(19) United States
(12) Patent Application Publication
(10) Pub. No.: US 2010/0079711 A1
(43) Pub. Date: Apr. 1, 2010

(54) LIQUID CRYSTAL DISPLAY DEVICE EQUIPPED WITH A PHOTOVOLTAIC CONVERSION FUNCTION

(75) Inventor: Hideo Tanaka, Tokyo (JP)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: TPO Hong Holding Limited, Shatin, Hong Kong (CN)

(21) Appl. No.: 11/993,765

(22) PCT Filed: Jun. 16, 2006
(86) PCT No.: PCT/JP2006/312124

§ 371 Date: Dec. 21, 2007

(30) Foreign Application Priority Data
Jun. 23, 2005 (JP) 2005-183531

(51) Int. Cl. G02F 1/133

(52) U.S. Cl. 349/116

(57) ABSTRACT

A solar cell construction in a display device is provided. The photovoltaic conversion can be performed with high efficiency by the solar cell construction. The display device includes a front substrate and an opposing rear substrate, which are light-transmissive. The display device further includes an optical control layer, a solar cell layer and an insulating flattened layer. The optical control layer is disposed between the substrates, wherein images formed by the optical control layer are displayed on the outer side of the front substrate. The solar cell layer is disposed in a specific area of the major surface on the rear substrate, between the rear substrate serving as a base for supporting it and the optical control layer, and receives incident light coming from the external surroundings through the rear substrate. The insulating flattened layer is formed on the solar cell layer, wherein the optical control layer is formed on and supported by the insulating flattened layer.

### BACKGROUND OF THE INVENTION

1. Field of Invention

The present invention relates to a liquid crystal display device equipped with a photovoltaic conversion function, and more particularly to a liquid crystal display device with a solar cell construction.

2. Related Art

In certain previous researches, there were proposed a technique of assembling solar cells in a liquid crystal display device where the solar cells generated the electricity required for the driving device and/or the battery charging device.

A liquid crystal display device of the above type has been disclosed in cited reference 1, where the device is a reflection type liquid crystal electro-optic device. In the display device according to this invention, a dispersion mold liquid crystal layer is sandwiched between two transparent substrates, and a solar cell is formed on the bottom substrate. By using one part of the solar cell as the active component, the technique for driving the dispersion mold liquid crystal layer separately and continuously is achieved.

Another liquid crystal display device of the above type has been disclosed in cited reference 2. The display device according to this invention includes the following components: a liquid crystal cell; a light source to irradiate the back face of the liquid crystal cell with light; a light guide plate to guide the light to the liquid crystal cell; a reflective polarizing means which is disposed between the liquid crystal cell and the light guide plate and which transmits the polarized light component required for the display by the liquid crystal cell but reflects the polarized light component different from the above component to the light guide plate side; a solar cell disposed in such a manner that the above reflected light is transmitted in the position opposing to the side face or the back face of the light guide plate.

Cited reference 1: Japanese Patent Publication No. 2000/2891 (with reference to paragraph [0010] and FIG. 1 in particular).

Cited reference 2: Japanese Patent Publication No. 2002/296590 (with reference to paragraph [0010] and FIG. 1 in particular).

However, with the display device described in cited reference 1, the incident light coming from the external surroundings of the upper substrate passes through the upper substrate and the liquid crystal layer, and is received by the solar cell formed on the bottom substrate. Before the incident light reaches the solar cell, there may be attenuation of the light to a certain extent, and thus, it is hard to attain high photovoltaic efficiency with the device. Moreover, the device utilizes the ambient light coming from the upper substrate, which also serves as a display section. When the user is not aware of the cell phone's display mode and the display section is covered up by some other objects, the solar cell is not able to generate electricity through photovoltaic conversion. Such situation is especially familiar to flip style cell phones, which have been a quite popular cell phone type recently, since the user tends to close the flip cover when the cell phone is not in use, with half part of the display section overlapping with half part of the keypad section. Under the circumstances, light is prohibited from entering the display section even though the surroundings are extremely bright.

The device described in cited reference 2 is based on a transmission type liquid crystal display device. This device uses the backlight provided by the light guide plate as a power source. That is to say, the device is mainly constituted by disposing a solar cell which receives the backlight at the back side of the light guide plate. The device according to this invention does not aim at producing photovoltaic conversion of external light that enters the liquid crystal panel. Besides, disposing the solar cell unit separate from the liquid crystal panel (“liquid crystal cell” in cited reference 2) tends to enlarge the size of the entire display system.

### SUMMARY OF THE INVENTION

The present invention is developed in view of the drawbacks described above. An object of the present invention is to provide a solar cell construction in a reflection type liquid crystal display device, or in other types of display device; photovoltaic conversion can be performed with high efficiency by said solar cell construction.

Another object of the present invention is to provide a display device in which power generation of the solar cell can be carried out effectively despite the fact that the display section is covered up by some other articles.

Still another object of the present invention is to provide a display device which is enabled to generate power by performing photovoltaic conversion for incident light entering the display panel, and which is advantageous in minimizing the size of the whole display system.

To achieve the above objects, the display device according to a first embodiment of the invention comprises a front substrate and an opposing rear substrate, both of the substrates being light-transmissive. The display device also comprises an optical control layer, which is disposed between said substrates. Images formed by the control layer are displayed on the outer side of the front substrate. The display device still comprises a solar cell layer, which is disposed in a specific area of the major surface on the rear substrate. The solar cell layer is formed between the rear substrate, which serves as a base for supporting it, and the optical control layer. The solar cell layer receives incident light coming from the external surroundings through the rear substrate. The display device further comprises an insulating flattened layer, which is formed on the solar cell layer. The optical control layer is formed on and supported by the flattened layer (claim 1).

As a result, incident light coming from the external surroundings through the rear substrate can be received by the solar cell layer, without much attenuation, since the solar cell layer is formed at one side of the rear substrate. Because of the arrangement described above, the display device of the present invention enables the performance of high efficiency photovoltaic conversion. Moreover, when the front substrate is covered up by some other objects, incident light coming into the rear substrate side can still be utilized for power generation. Furthermore, the solar cell layer is disposed altogether with the optical control layer, between the front substrate and the rear substrate. This arrangement integrates said interior components into the display panel to form a more compact entity, and reduces the size of the entire display system.

In this embodiment, the optical control layer may include a liquid crystal layer, a driving construction layer which corresponds to the image to be displayed and which is for driving said liquid crystal layer in individual pixels, a reflective layer which corresponds to the image formed on said liquid crystal layer and which reflects the incident light coming from the external surroundings of the front substrate (claim 2). Thus, the display device of the present invention uses incident light coming from the external surroundings of the front substrate to perform a reflection mode display, and at the same time, the device uses incident light coming from the external surroundings of the rear substrate to generate electricity.

In addition, said specific area may enclose the whole display area or its most part (claim 3) of the display device. Therefore, light can be received by a relatively larger area which is nearly the same size of the display area.

Besides, the solar cell layer may include: a transparent conductive layer at one side, which is formed on the inner surface of the rear substrate; p-type, i-type, n-type semiconductor layers respectively formed on said transparent conductive layer at one side; and a conductive layer at the other side formed on said n-type semiconductor layer (claim 4). As a result, a solar cell of PIN junction structure can be formed assuredly by using more common materials and more common manufacture techniques for typical display panels. It is preferable that the conductive layer at the other side is completely coupled to the outer surface of the n-type semiconductor layer (claim 5). This may help improve luminous efficiency of the solar cell layer.

The present invention can also be applied to other appliances than liquid crystal display devices. An optical control layer described above may include a layer that produces an image through electroluminescence (claim 6), which can be applied to fields like electroluminescent displays (ELDs). An optical control layer described above may also include a layer that produces an image by electrophoresis (claim 7), which can be applied to electronic ink displays in the field of electronic papers.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic section showing the first step of fabricating a liquid crystal display device according to an embodiment of the present invention;

FIG. 2 is a schematic section showing the second step of fabricating a liquid crystal display device according to an embodiment of the present invention;

FIG. 3 is a schematic section showing the third step of fabricating a liquid crystal display device according to an embodiment of the present invention;

FIG. 4 illustrates a functional architecture diagram of the power system within the display device in FIG. 3, with electricity introduced into the solar cell layer;

FIG. 5 is a front perspective view showing a flip style cell phone in an open position, with the cell phone incorporating the liquid crystal display device in FIG. 3; and

FIG. 6 is a front perspective view showing a flip style cell phone in a closed position, with the cell phone incorporating the liquid crystal display device in FIG. 3.

### DETAILED DESCRIPTION OF THE INVENTION

The present invention will be apparent from the following detailed description, which proceeds with reference to the accompanying drawings, wherein the same references relate to the same elements.

FIGS. 1 to 3 are schematic sections showing major steps for fabricating a liquid crystal display device according to an embodiment of the present invention.

FIG. 1 shows the step of forming a solar cell layer on a rear substrate. First, a rear substrate 100 made of glass or other light transmissive thin film is provided. With the substrate 100 as a base layer, a thin film, such as an indium tin oxide (ITO) thin film, is formed on it to constitute a transparent conductive layer 11. The transparent conductive layer 11 occupies most of the major surface area on the rear substrate 100, while as shown in FIG. 1, both ends of the conductive layer 11 do not exceed the ending boundaries of the rear substrate 100. In this embodiment, a solar cell of PIN structure is employed, and the transparent conductive layer 11 serves as an n-side electrode.

On the transparent conductive layer 11, a p-type semiconductor layer 12, i-type semiconductor layer 13 and n-type semiconductor layer 14 are deposited sequentially. The deposited area occupies most part or at least a substantial part of the display area. Then, this deposited area undergoes a pattern process. The individual p, i, n semiconductor layers, serving as three major layers for carrying out the photovoltaic effect in a PIN solar cell, are made of substances such as amorphous silicon (a-Si).

Next, electrical insulating materials, such as SiN or SiO₂, are deposited and patterned so that a hole 15h1 is formed, at which the upper surface part (preferably the most part) of the n-type semiconductor layer 14 can be exposed to a specific area. Similarly, a hole 15h2 is formed, at which the upper surface part of the transparent conductive layer 11 can be exposed to a specific area. Then, a first insulating layer 15 can be formed.

Next, conductive metallic materials, such as aluminum or copper, are deposited and patterned on the top to form an electrode layer 16 coupling to the n-type semiconductor layer 14 at the hole 15h1, and to form a separate electrode layer 17 coupling to the transparent conductive layer 11 at the hole 15h2. The electrode layer 16 and the electrode layer 17 serve as electrode terminals at one and the other side of the PIN solar cell respectively. Layers 11 to 17 described above constitute the solar cell layer 10.

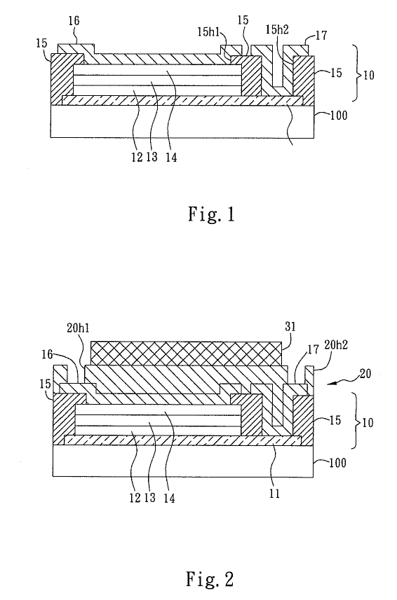

FIG. 2 shows an early stage disposition for integrating an essential part of the reflection type liquid crystal display device into the solar cell structure of FIG. 1. First, electrical insulating materials, such as SiN or SiO₂, are deposited and patterned so that a hole 20h1 is formed, at which the upper surface part (preferably the most part) of the electrode layer 16 can be exposed to a specific area (preferably an area near the end part). Similarly, a hole 20h2 is formed, at which the upper surface part of the electrode layer 17 can be exposed to a specific area (preferably an area near the end part). Then, a second insulating layer 20 can be formed. As shown in FIG. 2, the second insulating layer 20 in this embodiment includes a major portion (or insulating flattened layer) 201, which covers the most surface area of the solar cell layer and completely contains the surface area of the display section. This major portion could support an optical control layer 30 (described below), which, in a prior art display device, is placed between a pair of opposing substrates disposed at the front side and back side of a display panel. In the present invention, the major portion 201 is flattened to the extent that facilitates the support.

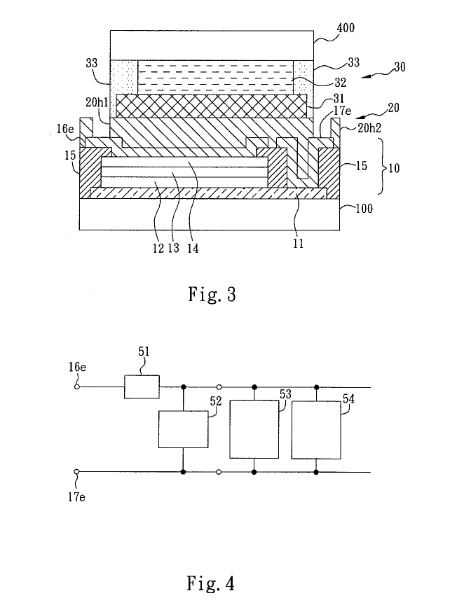

After the second insulating layer 20 is formed, it is then the step of forming the optical control layer 30 on the major portion 201. The optical control layer 30 in this embodiment, as shown in FIG. 3, includes a liquid crystal layer 30 and a driving construction layer 31 (comprising thin film transistor matrix serving as pixel driving components and other components connecting to the transistors, such as electrode wires in rows and columns, different kinds of insulating layers, directional films, etc.), which corresponds to the image to be displayed and which is for driving said liquid crystal layer in individual pixels. The optical control layer further includes a reflective layer that corresponds to the image formed on the liquid crystal layer 32 and which reflects the incident light coming from the external surroundings of the front substrate 400. In FIGS. 2 and 3, the illustrated driving construction layer 31 includes the reflective layer formed on the major portion 201. Other ways of forming the control layer 30 can be achieved by techniques utilized for a prior art reflection type liquid crystal display device; relevant description of various embodiments can be found in many literatures and is thus omitted here.

After the optical control layer 30 is formed, it is then the step of combining with the front layer 400 made up of light-transmissive materials. Here, sealing materials 33 are used to seal the liquid crystal layer 32. A color-filter layer, shared electrodes, and a directional film (not shown) are disposed inside the inner surface of the front substrate 400.

As a result, the solar cell layer 10, the second insulating layer 20, and the optical control layer 30 are respectively formed in order between the rear substrate 100 and the front substrate 400, as shown in FIG. 3.

In the solar cell layer 10, the p-type semiconductor layer 12 receives incident light coming from external surroundings of the rear substrate 100, through the rear substrate 100 and the transparent conductive layer 11. The received light enables the main semiconductor layers 12, 13 and 14 to exert photovoltaic effect; the generated electricity can be obtained from electrode terminal 16e of the electrode layer 16 and from electrode terminal 17e of the electrode layer 17. Practices of the photovoltaic effect produced by such PIN solar cells have been disclosed in many previous literatures, e.g. cited reference 1, and are not explained with further details herein.

FIG. 4 shows a general construction of the power system of the display device for which electricity is generated from the solar cell layer 10 described above.

In FIG. 4, the electrode terminal 16e is coupled to one electrode of second cell 52 through backflow prevention diode 51, and the electrode terminal 17e is coupled to the other electrode of the second cell 52. The electrodes of the second cell 52 are coupled to power input terminals of panel driving circuit 53 and system control circuit 54 for the display device, and thus, required power is provided to each circuit. The power generated by the solar cell layer 10 is stored in the second cell 52 after going through the electrode terminals 16e and 17e.

In the optical control layer 30, the image to be displayed drives the liquid crystal layer in individual pixels. Incident light coming from the external surroundings of the front substrate 400 is optically controlled by liquid crystal layer, reflected at the reflective layer (not shown; formed in the driving construction layer), and reflected back, as image display light, to go forward through the outer side of the front substrate layer.

As a result, at the front side of the display device, incident light is used for image display, while at the rear side of the display device, incident light is used for power generation. Such utilization is very helpful for a reflection type liquid crystal display as in the present embodiment. When the rear side of the display panel is not covered up by the user, the incident light can come through both the front and rear sides of the device, rather than come through the front side of the display device only. The display panel of the device is of a reflection type, and therefore, the incident light coming from the front side can be used for image display. In addition, at the rear side of the device, other incident light can be received to generate power effectively. It should be further noticed that the incident light coming from the rear substrate 100 undergoes attenuation to a lesser extent. Hence, the solar cell 10 could receive light more effectively and could exert photovoltaic conversion with higher efficiency.

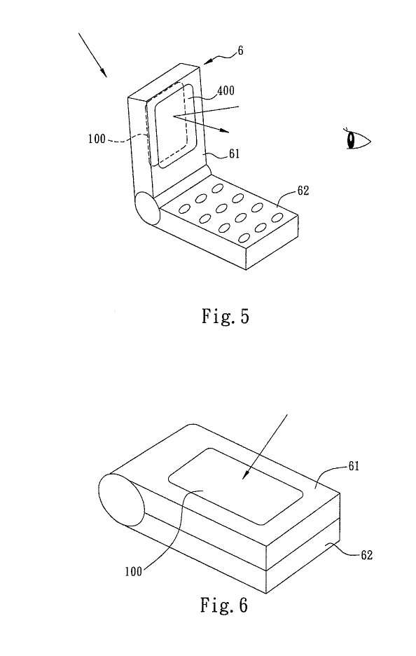

Even when the display section, i.e., the front substrate 400, is covered up by some other objects, power generation by the solar cell can still be carried out. More details will be elaborated below with reference to FIGS. 5 and 6. FIG. 5 shows a flip style cell phone with the user looking at the display section for accessing information.

A cell phone 6 comprises the front substrate 400 at the front side of the display section and the rear substrate 100 at the rear side of the display section. The user sees the image which is reflected by the incident light coming into the display section of the cell phone 6, and the incident light coming into the rear substrate 100 is received at the rear side of the cell phone 6.

FIG. 6 shows the cell phone 6 in a closed position, with a display section 61 overlapping an operative section 62. In this condition, the front substrate 400 is covered up within the sections 61 and 62 where incident light can not enter. However, incident light can be received by the rear substrate 100 still, and moreover, its light receiving ability may be better than that is in FIG. 5. As a consequence, power generation that utilizes incident light can still be carried out effectively, though the user is not using the display section.

In addition, rather than being formed separately from the display panel, the solar cell structure of the display device described above is integrated into the display panel to form a compact entity. The solar cell structure and the display element (the optical control layer) are formed altogether between the substrates used for the display panel. Such arrangement is advantageous in reducing the size of the entire display system.

The above description has delineated a representative embodiment of the present invention; nonetheless, it should be understood that the present invention is not limited hereto. Those having ordinary skill in the art will recognize additional modifications and embodiments within the scope of the claims attached hereto.

The aforementioned embodiment describes a display device using incident light to perform a reflection mode display. The present invention, however, can be applied to a display device having front lights formed on the front substrate 400 as well. The aforementioned embodiment describes a liquid crystal device having the liquid crystal layer on the optical control layer, but the present invention is not limited hereto. For example, the optical control layer may include a layer that produces an image through electroluminescence, and may also include a layer that produces an image by electrophoresis. It should thus be understood and noted: the present invention is not limited to a reflection type display device, nor limited to a liquid crystal device.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A display device comprising a front substrate and an opposing rear substrate, with both of the substrates being light-transmissive; an optical control layer, which is disposed between said substrates, wherein images formed by the optical control layer are displayed on the outer side of the front substrate; and comprising:
a solar cell layer, which is disposed in a specific area of the major surface on the rear substrate, between the rear substrate serving as a base for supporting it and the optical control layer, and which receives incident light coming from the external surroundings through the rear substrate; and
an insulating flattened layer formed on the solar cell layer, wherein the optical control layer is formed on and supported by the flattened layer.

2. The display device of claim 1, wherein the display device is an reflection type liquid crystal display device, and wherein the optical control layer includes a liquid crystal layer, a driving construction layer which corresponds to the image to be displayed and which is for driving said liquid crystal layer in individual pixels, and a reflective layer which corresponds to the image formed on said liquid crystal layer and which reflects the incident light coming from the external surroundings of the front substrate.

3. The display device of claim 1, wherein the specific area encloses the whole display area or the most part of the display device.

4. The display device of claim 1, wherein the solar cell layer includes: a transparent conductive layer at one side, which is formed on the inner surface of the rear substrate; p-type, i-type, n-type semiconductor layers respectively formed on said transparent conductive layer at one side; and a conductive layer at the other side formed on said n-type semiconductor layer.

5. The display device of claim 4, wherein the conductive layer at the other side is completely coupled to the outer surface of the n-type semiconductor layer.

6. The display device of claim 1, wherein the optical control layer includes a layer that produces an image through electroluminescence.

7. The display device of claim 1, wherein the optical control layer includes a layer that produces an image by electrophoresis.
